(19) United States
(12) Patent Application Publication
(10) Pub. No.: US 2025/0236937 A1
(43) Pub. Date: Jul. 24, 2025

(54) HOT STAMPING ALLOY WITH IMPROVED WELDABILITY AND PARTS MADE FROM SUCH ALLOY

(71) Applicant: GM GLOBAL TECHNOLOGY OPERATIONS LLC, Detroit, MI (US)

(72) Inventors: Zhenke TENG, Troy, MI (US); Zhou WANG, Shanghai (CN); Zhao LI, Shanghai (CN); Jianfeng WANG, Nanjing (CN); Jason M. BROWN, Goodrich, MI (US)

(21) Appl. No.: 18/637,062

(22) Filed: Apr. 16, 2024

(30) Foreign Application Priority Data
Jan. 19, 2024 (CN) 2024100842361

(51) Int. Cl. C22C 38/38; B62D 29/00; C22C 38/00; C22C 38/02; C22C 38/04; C22C 38/34

(52) U.S. Cl. CPC C22C 38/38; B62D 29/007; C22C 38/005; C22C 38/02; C22C 38/04; C22C 38/34

(57) ABSTRACT

A metal alloy suitable for hot stamping comprises between about 0.05 wt % and about 0.45 wt % carbon; between about 0.5 wt % and about 4.5 wt % manganese; between about 0.5 wt % and about 6 wt % chromium; between about 0.5 and about 2.5 wt % Si, between about 0.1 wt % and about 0.3 wt % yttrium, the balance being iron and impurities. Structural parts with improved weldability are made by hot stamping a blank of the metal alloy.

### CROSS-REFERENCE TO RELATED APPLICATIONS

This application claims the benefit of Chinese Patent Application No. 202410084236.1, filed on Jan. 19, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to alloys for hot stamping of structural parts, such as structural automotive parts, and to structural parts made from such alloys.

A common method of manufacturing structural automotive parts is hot stamping, also referred to as press hardening. However, with commonly used alloys such as 22MnB5, hot stamping can result in heavily oxidized parts-parts with thick and/or uneven oxide coatings, which can make subsequent spot welding of such parts difficult and prone to whiskering. To reduce the formation of these oxide coatings, the hot stamping can be performed in an inert atmosphere, but even with an inert atmosphere, the oxidation can be so severe that the parts must be blast-cleaned before spot welding. This complicates the manufacturing process, and increases costs. Alternatively, coatings such as AlSi can be applied to the blanks from which the parts are hot stamped, but this also complicates the manufacturing process, and increases cost.

Hot stamping alloys have been developed which are more resistant to the formation of oxides during the hot stamping process. One common coating free press hardened steel (CFPHS) is a novel steel grade patented by General Motors Company has a nominal composition of 0.05-0.45 wt % C, 0-0.45 wt % Mn, 0.5-6 wt % Cr, 0.5-2.5 wt % Si, the balance being iron. However, these alloys can be difficult to later spot weld during subsequent manufacturing, because the non-uniform surface oxides facilitate whiskering, which leads to undesirable appearance, and can even impact air bag deployment and can present problems for materials handlers in production.

### SUMMARY

Further areas of applicability of the present disclosure will become apparent from the detailed description, the claims and the drawings. The detailed description and specific examples are intended for purposes of illustration only and are not intended to limit the scope of the disclosure.

Embodiments of this disclosure provide an improved metal alloy suitable for hot stamping. According to a first embodiment, the alloy can comprise between about 0.05 and about 0.45 wt % carbon; between about 0.5 and about 4.5 wt % manganese; between about 0.5 and about 6 wt % chromium; between about 0.5 and about 2.5 wt % Si, and sufficient yttrium to achieve a thin (on the order of about 0.5 μm or less) uniform surface oxide layer, and the balance being iron and impurities. In some embodiments of this disclosure the thin, uniform surface oxide layer is achieved when the yttrium content is at least about 0.1 wt %, and increases beyond 0.3 wt % but generally shows no significant additional improvement, although the beneficial effects of yttrium are experienced with yttrium contents up to about 0.5 wt %, where the higher yttrium costs and problems with steel casting and rolling make further increases in yttrium undesirable.

In some versions of this first embodiment, it may be desirable to keep the total of the Cr and Si content to less than or equal to about 5 wt % for easier scale removal in steel mill. In some versions of this first embodiment, it may be desirable to keep the ratio of chromium:silicon between about 1.25:1 and about 3:1 for high temperature oxidation resistance during hot stamping.

The alloy does not need to be processed in a protective atmosphere such as nitrogen or argon, and processing generally results in a thin, uniform oxide coating less than? 0.5 μm thick, and typically on the order of 0.1 μm to 0.3 μm thick. This thin uniform oxide layer reduces the occurrence of spot welding defects and whiskers that? occur with the thicker and/or less uniform oxide coatings that develop on existing hot stamping alloys.

According to a second embodiment of this disclosure, structural parts with reduced susceptibility to whiskering from spot welding are provided. According to the second embodiment, a structural part, such as an automotive structural part, made of between about 0.05 and about 0.45 wt % carbon; between about 0.5 and about 4.5 wt % manganese; between about 0.5 and about 6 wt % chromium; between about 0.5 and about 2.5 wt % Si, between about 0.1 and about 0.3 wt % yttrium, the balance being iron and impurities, shaped by hot stamping with a substantially uniform oxidation thickness after hot stamping of less than about 0.5 μm. This part can be, for example, automotive pillars, door beams and bumper beams.

Hot stamping products from blanks of this alloy results in parts with a thin, uniform oxide coating that does not need blasting or other processing steps. The thin, substantially uniform oxide coating reduces the incidence of whiskering when the parts are subsequently spot welded.

### BRIEF DESCRIPTION OF THE DRAWINGS

The present disclosure will become more fully understood from the detailed description and the accompanying drawings, wherein:

FIG. 1 is a cross-sectional view of a hot stamped part made of conventional 22MnB5 alloy, showing a very thick oxide coating of about 63 μm;

FIG. 2 is a cross-sectional view of a hot stamped part made of conventional CFPHS alloy, showing an uneven, thick oxide coating of up to about 5 μm;

FIG. 3 is a cross-sectional view of a hot stamped part made of conventional CFPHS alloy with an addition of 0.05 wt % yttrium, showing an uneven, thick oxide coating of up to about 10 μm;

FIG. 4 is a cross-sectional view of a hot stamped part made of an alloy according to embodiments of this disclosure with 0.2 wt % yttrium, showing an even, thin oxide coating about 0.13 μm thick;

FIG. 5 is a photomicrograph of a spot weld on a conventional CFPHS alloy, showing surface melting and whiskers;

FIG. 6 is a photomicrograph of a spot weld on embodiments of this disclosure with 0.2 wt % yttrium, showing no surface melting and whiskers;

FIG. 7 is a cross-sectional view of a spot weld between two hot stamped parts made of an alloy according to embodiments of this disclosure;

FIG. 8 is a cross-sectional view of a spot weld between two hot stamped parts made of a conventional CFPHS alloy; and

FIG. 9 is a graph showing the acceptable spot welding current range for a hot stamped part made of a conventional CFPHS alloy and a hot stamped part made of an alloy according to embodiments of this disclosure.

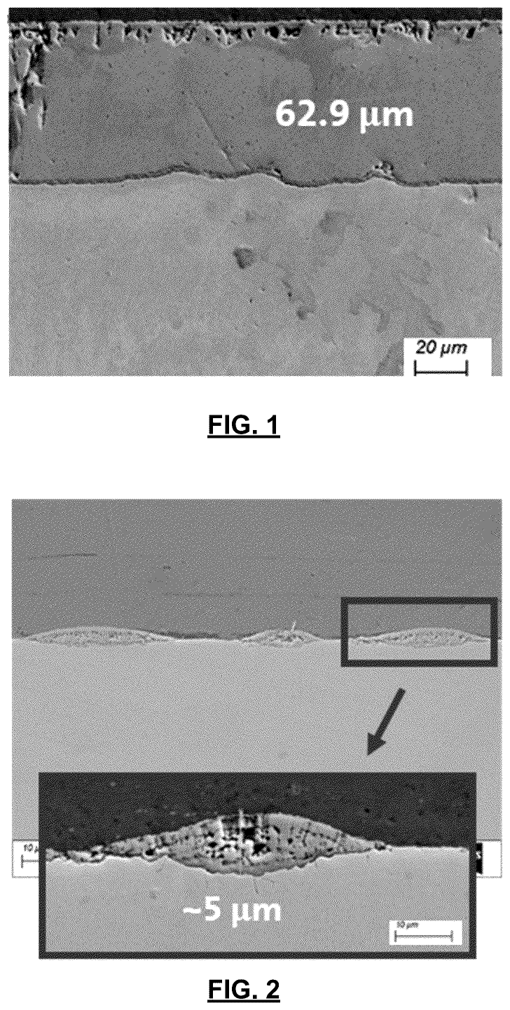

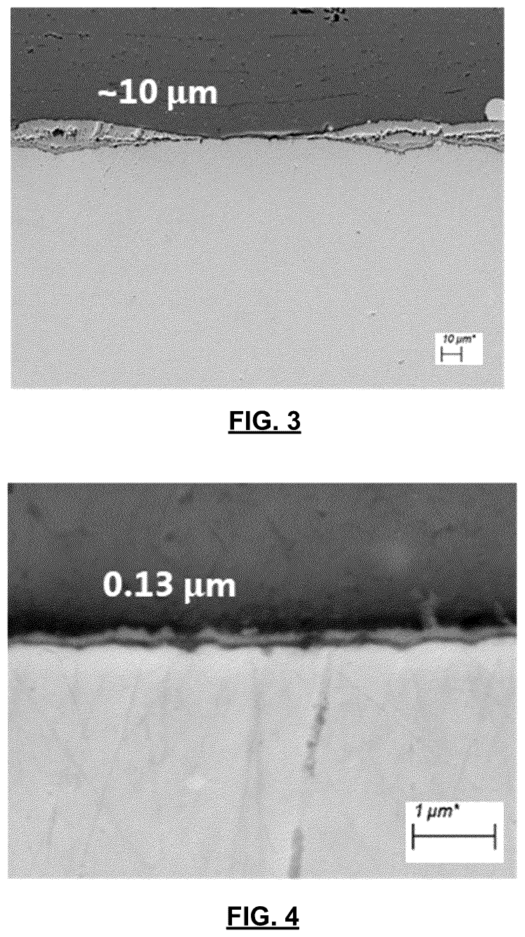

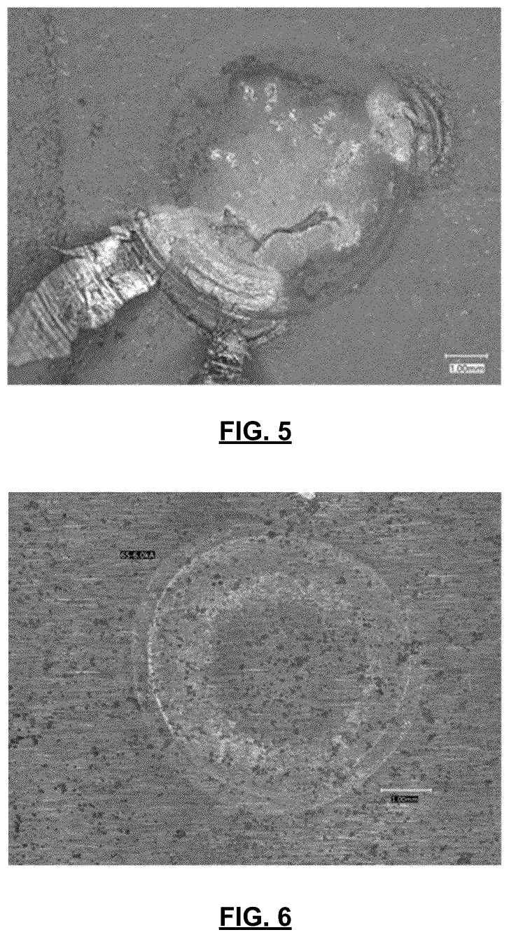

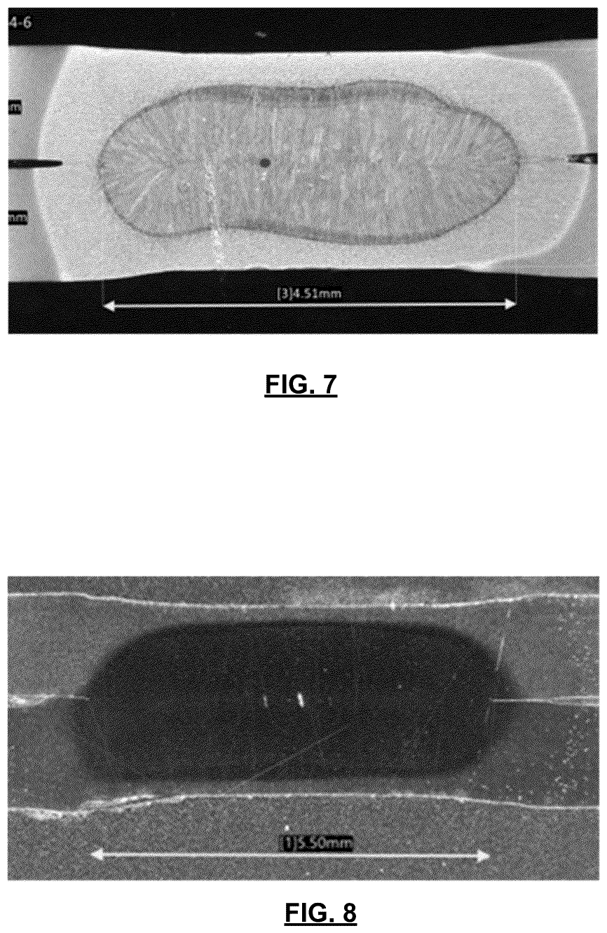

### DETAILED DESCRIPTION

Embodiments of this disclosure provide an improved metal alloy suitable for hot stamping. According to a first embodiment, the alloy can comprise between about 0.05 and about 0.45 wt % carbon; between about 0.5 and about 4.5 wt % manganese; between about 0.5 and about 6 wt % chromium; between about 0.5 and about 2.5 wt % Si, a sufficient amount of yttrium to yield hot stamped parts with a substantially uniform oxide coating of less than about 0.5 μm, the balance being iron and impurities. In some embodiments, the yttrium content is at least 0.1 wt %. Yttrium content above about 0.3 wt % yields diminishing returns although the beneficial effects of yttrium are experienced with yttrium contents up to about 0.5 wt %, where the higher yttrium costs and problems with steel casting and rolling make further increases in yttrium undesirable.

In some versions of this first embodiment, it may be desirable to keep the total wt % content of the chromium and silicon to less than or equal to about 5 wt % for easier scale removal in steel mill. In some versions of this first embodiment, it may be desirable to keep the wt % ratio of chromium:silicon to between about 1.25:1 and about 3:1 for high temperature oxidation resistance during hot stamping.

The alloy does not need to be processed in a protective atmosphere such as in nitrogen or argon, and processing generally results in a thin, uniform oxide coating less the 1 μm thick, typically less than 0.5 μm thick, and often between 0.1 and 0.3 μm thick, and less than 0.2 μm thick. The thin uniform oxide layer results in spot welding with less surface melting and little to no whiskering.

According to a second preferred embodiment of this disclosure, hot stamped parts such as automotive parts are provided. According to the second embodiment, a structural part, such as an automotive structural part, made of an alloy comprising between about 0.05 and about 0.45 wt % carbon; between about 0.5 and about 4.5 wt % manganese; between about 0.5 and about 6 wt % chromium; between about 0.5 and about 2.5 wt % Si, between about 0.1 and about 0.5 wt % yttrium, the balance being iron and impurities, shaped by hot stamping with a substantially uniform oxidation thickness after hot stamping of less than about 0.5 μm, and in some embodiments less than 0.15 μm. This part can be, for example, automotive pillars, door beams and bumper beams.

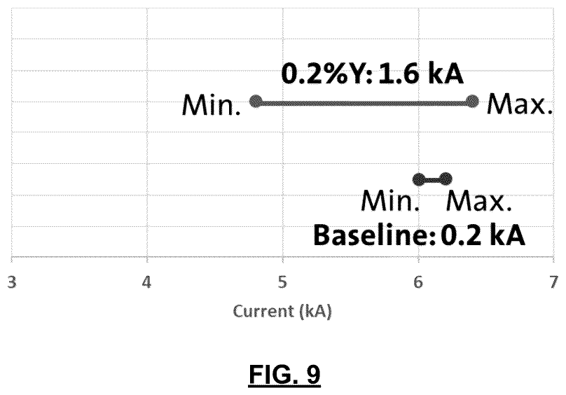

The thin, substantially uniform oxide coating improves spot welding, reducing the occurrence of surface melting and whiskering. Furthermore, as shown in FIG. 9, the welding current window to achieve a satisfactory weld in increased from a range of 0.2 kA for a conventional CFPHS alloy, to a range of 1.6 kA for acceptable spot welds for alloys according to the embodiments of this disclosure.

The compositions of this disclosure can result in lower part costs because protective atmosphere is no longer required during hot stamping to control oxidation, and reduced scrap rate from unsatisfactory spot welds.

What is claimed is:

1. A metal alloy suitable for hot stamping, the alloy comprising between about 0.05 and about 0.45 wt % carbon; between about 0.5 and about 4.5 wt % manganese; between about 0.5 and about 6 wt % chromium; between about 0.5 and about 2.5 wt % silicon, between about 0.1 and about 0.5 wt % yttrium, and the balance being iron and impurities.

2. The metal alloy according to claim 1 wherein there is between about about 0.1 wt % and about 0.3 wt % yttrium.

3. The metal alloy according to claim 2 wherein there is about 0.2 wt % yttrium.

4. The metal alloy according to claim 2 wherein the total of the chromium and silicon contents is less than or equal to about 5 wt %.

5. The metal alloy according to claim 3 wherein the ratio of the wt % of chromium:silicon is between about 1.25 and about 3.

6. The metal alloy according to claim 2 wherein the ratio of the wt % of chromium:silicon is between about 1.25 and about 3.

7. An automotive structural part made of an alloy comprising between about 0.05 and about 0.45 wt % carbon; between about 0.5 and about 4.5 wt % manganese; between about 0.5 and about 6 wt % chromium; between about 0.5 and about 2.5 wt % silicon, between about 0.1 and about 0.5 wt % yttrium, the balance being iron and impurities, shaped by hot stamping with a substantially uniform oxidation thickness after hot stamping of less than about 0.5 μm.

8. The automotive structural part according to claim 7 wherein the part is made of an alloy comprising between about 0.1 wt % and about 0.3 wt % yttrium.

9. The automotive structural part according to claim 8 wherein the part is made of an alloy comprising about 0.2 wt % yttrium.

10. The automotive structural part according to claim 8 having a substantially uniform oxidation thickness after hot stamping of less than about 0.3 μm.

11. The automotive structural part according to claim 10 having a substantially uniform oxidation thickness after hot stamping of less than about 0.2 μm.

12. The automotive structural part according to claim 11 comprising about 0.2 wt % yttrium.

13. The automotive structural part according to claim 8 wherein the total of the total of chromium and silicon contents is less than or equal to about 5 wt %.

14. The automotive structural part according to claim 13 wherein the ratio of the wt % of chromium:silicon is between about 1.25 and about 3.

15. The automotive structural part according to claim 8 wherein the ratio of the wt % of chromium:silicon is between about 1.25 and about 3.

16. The automotive structural part according to claim 8 wherein the part does not whisker upon spot welding.

17. The automotive structural part according to claim 8, wherein the part is an automotive pillar, a door beam, or a bumper beam.

18. The automotive structural part according to claim 17 wherein the part does not whisker upon spot welding.

19. The automotive structural part according to claim 18 wherein the part is made of an alloy comprising between about 0.1 wt % and about 0.3 wt % yttrium.

20. The automotive structural part according to claim 19 wherein the part is made of an alloy comprising about 0.2 wt % yttrium.
